(19) United States
(12) Patent Application Publication
(10) Pub. No.: US 2006/0136220 A1
(43) Pub. Date: Jun. 22, 2006

(54) Controlling user interfaces with voice commands from multiple languages

(76) Inventors: Rama Gurram, San Jose, CA (US); Frances James, Sunnyvale, CA (US)

Correspondence Address: FISH & RICHARDSON, P.C., PO BOX 1022, MINNEAPOLIS, MN, 55440-1022, US

(21) Appl. No.: 11/017,889

(22) Filed: Dec. 22, 2004

(51) Int. Cl. G10L 21/00

(52) U.S. Cl. 704/275

(57) ABSTRACT

One or more internationalized voice user interfaces include a user interface and a voice extension module associated with the user interface. The voice extension module is configured to voice-enable the user interface and includes a speech recognition engine, a preprocessor, and an input handler. The preprocessor is configured to register with the speech recognition engine one or more voice commands for controlling the user interface. The one or more voice commands are representative of multiple languages. The input handler receives an initial voice command that is representative of one of the multiple languages and communicates with the preprocessor to control the user interface as indicated by the initial voice command. The initial voice command is one of the one or more voice commands registered with the speech recognition engine by the preprocessor.

### CROSS REFERENCE TO RELATED APPLICATIONS

This application is being filed concurrently with U.S. application Ser. No. ______ [Docket 13909-169001], titled “Controlling User Interfaces with Contextual Voice Commands”.

### TECHNICAL FIELD

This document relates to voice controlled user interfaces.

### BACKGROUND

Much of software used in business today takes the form of complex graphical user interfaces (GUIs). Complex GUIs allow users to perform many tasks simultaneously while maintaining the context of the rest of their work; however, such systems are often mouse- and keyboard-intensive, which can be problematic or even impossible to use for many people, including those with physical disabilities. Voice interfaces can provide an accessible solution for physically disabled users if steps are taken to address inherent usability problems, such as user efficiency and ambiguity handling. Additionally, voice interfaces may increase the efficiency of performing certain tasks.

Large resources have been expended to develop web-based applications to provide portable, platform-independent front ends to complex business applications using, for example, the hypertext markup language (HTML) and/or JavaScript. Because software applications have typically been developed with only the visual presentation in mind, little attention has been given to details that would facilitate the development of voice interfaces.

In most computer or data processing systems, user interaction is provided using only a video display, a keyboard, and a mouse. Additional input and output peripherals are sometimes used, such as printers, plotters, light pens, touch screens, and bar code scanners; however, the vast majority of computer interaction occurs with only the video display, keyboard, and mouse. Thus, primary human-computer interaction is provided through visual display and mechanical actuation. In contrast, a significant proportion of human interaction is verbal. Various technologies have been developed to provide some form of verbal human-computer interactions, ranging from simple text-to-speech voice synthesis applications to more complex dictation and command-and-control applications. It is desirable to further facilitate verbal human-computer interaction to increase access for disabled users and to increase the efficiency of user interfaces.

### SUMMARY

In one general aspect, an internationalized voice user interface includes a user interface and a voice extension module. The voice extension module is associated with the user interface and is configured to voice-enable the user interface. The voice extension module includes a speech recognition engine, a preprocessor, and an input handler. The preprocessor is configured to register with the speech recognition engine one or more voice commands for controlling the user interface. The one or more voice commands are representative of multiple languages. The input handler receives an initial voice command that is representative of one of the multiple languages and communicates with the preprocessor to control the user interface as indicated by the initial voice command. The initial voice command is one of the one or more voice commands registered with the speech recognition engine by the preprocessor.

Implementations may include one or more of the following features. The voice extension module may include a language specific data store that includes information that identifies at least one voice command for controlling the user interface. The at least one voice command may be representative of at least one of the multiple languages. The preprocessor may identify one of the multiple languages that will be used to provide voice commands for controlling the user interface and may register with the speech recognition engine one or more voice commands for controlling the user interface. The one or more voice commands may be representative of the identified language. The preprocessor may register with the speech recognition engine only one or more voice commands that are representative of the identified language. The voice extension module may include a speech application programming interface (API) library that enables the preprocessor to register the voice commands with the speech recognition engine and that enables the speech recognition engine to communicate the initial voice command to the input handler.

The preprocessor may include a parser and a translator. The parser may be configured to parse the user interface to identify one or more user interface elements included in the user interface. The translator may be configured to register with the speech recognition engine one or more voice commands for controlling the one or more identified user interface elements. The one or more voice commands may be representative of multiple languages.

The user interface may be a hypertext markup language (HTML) document presented in a web browser, or a standalone application. The user interface may be a user interface for a web services application.

In another general aspect, a voice extension module for internationalizing a voice-enabled user interface includes a speech recognition engine, a preprocessor, and an input handler. The preprocessor is configured to register with the speech recognition engine one or more voice commands for controlling a user interface. The one or more voice commands are representative of multiple languages. The input handler receives an initial voice command that is representative of one of the multiple languages and communicates with the preprocessor to control the user interface as indicated by the initial voice command. The initial voice command is one of the one or more voice commands registered with the speech recognition engine by the preprocessor.

Implementations may include one or more of the following features. The voice extension module may include a language specific data store that includes information that identifies at least one voice command for controlling the user interface. The at least one voice command may be representative of at least one of the multiple languages.

The preprocessor may identify one of the multiple languages that will be used to provide voice commands for controlling the user interface. The preprocessor may register with the speech recognition engine one or more voice commands for controlling the user interface. The one or more voice commands may be representative of the identified language. The preprocessor may be further configured to register with the speech recognition engine only voice commands that are representative of the identified language.

The voice extension module may include a speech application programming interface (API) that may enable the preprocessor to register the voice commands with the speech recognition engine. The speech API also may enable the speech recognition engine to communicate the initial voice command to the input handler.

The preprocessor may include a parser and a translator. The parser may be configured to parse the user interface to identify one or more user interface elements included in the user interface. The translator may be configured to register with the speech recognition engine one or more voice commands for controlling the one or more identified user interface elements. The one or more voice commands may be representative of multiple languages.

In another general aspect, providing an internationalized voice user interface includes accessing information specifying a user interface. One or more voice commands for controlling the user interface may be registered with a speech recognition engine to enable voice control of the user interface. The one or more voice commands may be representative of multiple languages. The user interface is controlled as indicated by an initial voice command that is representative of one of the multiple languages. The initial voice command is one of the one or more voice commands registered with the speech recognition engine.

Implementations may include one or more of the following features. Registering one or more voice commands may include identifying one of the multiple languages that will be used to provide voice commands for controlling the user interface. One or more voice commands that may be used to control the user interface may be registered with the speech recognition engine. The one or more voice commands may be representative of the identified one of the multiple languages. Registering one or more voice commands that are representative of the identified one of the multiple languages may include registering one or more voice commands that are representative of only the identified one of the multiple languages.

Registering one or more voice commands that may be used to control the user interface may include parsing the information specifying the user interface to identify one or more user interface elements included in the user interface. One or more voice commands for controlling each of the one or more identified user interface elements may be registered.

Registering the one or more voice commands that are representative of the multiple languages may include registering one or more voice commands that are representative of one of the multiple languages based on the information specifying the user interface. One or more other voice commands that are representative of another of the multiple languages may be registered based on the one or more voice commands that are representative of the one of the multiple languages.

The initial voice command may be clarified such that the initial voice command corresponds only to a manner in which the user interface is controlled in response to the initial voice command. Feedback that is representative of a language that is represented by the initial voice command may be provided.

These general and specific aspects may be implemented using a system, a method, or a computer program, or any combination of systems, methods, and computer programs. Other features will be apparent from the description and drawings, and from the claims.

### DESCRIPTION OF DRAWINGS

FIG. 1 is a block diagram of a voice-enabled computer application that uses a voice extension module.

FIG. 2 is a block diagram of a voice extension module of a voice-enabled computer application.

FIG. 3 is a flow chart of a process for registering voice commands that may be used to control a voice-enabled computer application.

FIG. 4 is a flow chart of a process for controlling a voice-enabled computer application in response to a voice command.

FIGS. 5-7 are screen shots of a user interface for a voice-enabled computer application.

### DETAILED DESCRIPTION

In one or more implementations, a user interface to a software application or an electronic device is voice-enabled to facilitate interaction with the user interface. A user may navigate to, or enter data in, graphical elements included in the user interface using voice commands. More particularly, the user may issue voice commands that are representative of multiple languages to control the user interface elements. Operations performed in response to the voice commands represent interactions with the user interface that may have been performed otherwise with a keyboard and a mouse. The user interface to the software application is voice-enabled without modifying the application. More particularly, a voice extension module is used to enable voice commands to signal for execution of operations for controlling graphical elements of the user interface and the software application.

In particular implementations, enabling a user to control the user interface elements with voice commands enables the user to interact with the user interface efficiently, because the user is not required to manually control the user interface elements with a keyboard and a mouse. As a result, the user interface has a greater usability and accessibility than other user interfaces that are not voice-enabled, particularly for physically disabled users and other users that may have difficulty generating manual input.

Supporting multiple languages (for example, English and Chinese) with a single voice extension module enables the single voice extension module to be used in multiple localities in which the multiple languages are used. More particularly, the single voice extension module does not need to be modified in order be used in each of the multiple locations. As a result, the single voice extension module may be widely and rapidly deployed across the multiple locations with little or no customization. Furthermore, the single voice extension module may enable interaction in multiple languages at once, which may be necessary, for example, when multiple users that are most comfortable with different languages are simultaneously using a user interface that has been voice-enabled with the single voice extension module.

The voice extension module may obviate the need to modify an application in order to support voice control of user interfaces. As a result, user interfaces of existing applications may be provided with a voice extension module to voice-enable the user interfaces such that graphical elements of the user interfaces may be controlled in response to single voice commands. Thus, a voice extension module supporting multiple languages may provide or enable a multi-language voice-enabled user interface to a large variety of applications without modifying the applications.

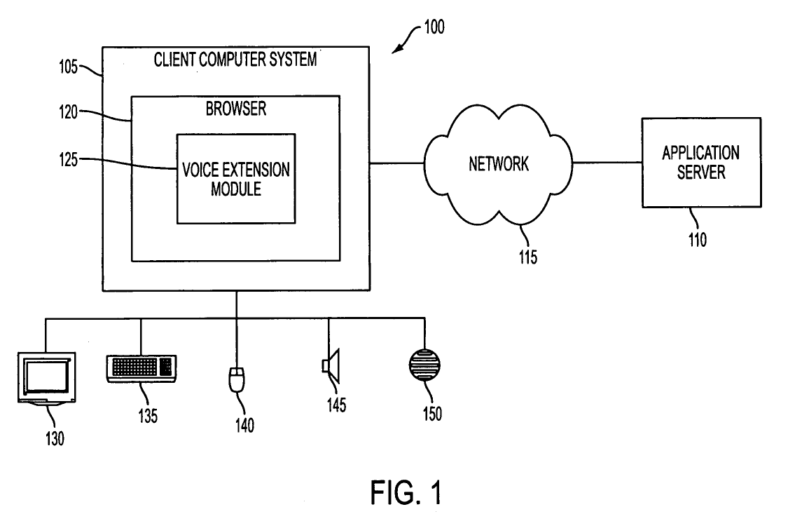

Referring to FIG. 1, a voice-enabled computer interface 100 includes a client computer system 105 that enables a user to interact with an application provided by an application server 110 over a network 115. The client computer system 115 includes a browser 120 in which a web-based user interface to the application is presented, and the browser 120 includes a voice extension module 125. The browser 120 enables user interaction with the application using one or more of a video display monitor 130, a keyboard 135, a mouse 140 and a speaker 145. The voice extension module 125 may receive input from a microphone 150.

The client computer system 105 is a computer system used by a user to access and interact with an application provided by the application server 110. The client computer system 105 provides a user interface to the application that enables the user to access and interact with the application. More particularly, the client computer system 105 presents output from the application and the user interface to the user, and receives input for the application and the user interface from the user. The client computer system 105 also communicates with the application server 110 to enable the user of the client computer system 105 to monitor and control execution of the application.

The application server 110 is a computer system on which the application is executed. The application server 110 also provides access to the application to the client computer system 105. For example, the application server 110 may provide information specifying a user interface for the application to the client computer system 105. The application server 110 also may provide information to be presented to the user on the user interface to the client computer system 105. The application server 110 also may receive input generated by the user of the client computer system 105, and the received input may be used to control execution of the application.

The network 115 is a network that connects the client computer system 105 to the application server 110. For example, the network 115 may be the Internet, the World Wide Web, one or more wide area networks (WANs), one or more local area networks (LANs), analog or digital wired and wireless telephone networks (e.g. a public switched telephone network (PSTN), an integrated services digital network (ISDN), or a digital subscriber line (xDSL)), radio, television, cable, satellite, and/ or any other delivery mechanism for carrying data. The client computer system 105 and the application server 110 are connected to the network 115 through communications pathways that enable communications through the network 115. Each of the communication pathways may include, for example, a wired, wireless, cable or satellite communication pathway, such as a modem connected to a telephone line or a direct internetwork connection. The client computer system 105 and the application server 110 may use serial line internet protocol (SLIP), point-to-point protocol (PPP), or transmission control protocol/internet protocol (TCP/IP) to communicate with one another over the network 115 through the communications pathways.

The browser 120 is configured to enable a user to access, monitor, and control the application executing on the application server 110. More particularly, the browser 120 is configured to receive a web-based user interface to an application specified from the application server 110 over the network 115. The web-based user interface may be specified as Hypertext Markup Language (HTML) code or JavaScript code. The HTML code describes various text, images, and user interface elements to be displayed to the user. The HTML code may instruct the browser 120 to display information describing the operation of the application and to accept user input and commands. For example, the user may be enabled to specify parameters or data needed by the application with the browser 120. The browser 120 also may receive metadata describing functions that are provided by the user interface from the application server 110. The browser 120 may be a conventional web browser, such as Internet Explorer, which is provided by Microsoft Corporation of Redmond, Wash.

The web-based user interface presented with the browser 120 may have been designed to facilitate controlling graphical elements of the user interface with voice commands that are representative of multiple languages. For example, the user interface may have been designed to include a minimal number of input-only user interface elements, which are user interface elements that only take input from a user. More particularly, output only user interface elements or mixed input/output user interface elements may be used instead of input only user interface elements. Output only user interface elements only present information to the user, and mixed input/output user interface elements present information to the user and receive input from the user. Text fields are an example of an input only user interface element, and labels are an example of an output only user interface element. Selection lists and buttons are examples of mixed input/output user interface elements. Appropriate voice commands that are representative of multiple languages typically are more easily identified for output only and mixed input/output user interface elements than for input only user interface elements. In addition, the user interface may have been designed such that easily internationalized methods for providing audio output to the user, such as text-to-speech (TTS) systems, are used instead of recorded audio files, which are not easily internationalized.

The voice extension module 125 voice-enables the web-based user interface presented with the browser 120. The voice extension module 125 may be implemented as a Microsoft Internet Explorer Browser Helper Object (BHO), or as an Internet Explorer Toolbar Component. A BHO acts as an extension of functionality of the browser 120 and is used to intercept page and browser 120 events before action is taken. This allows the voice extension module 125 to define and control the behavior of the browser 120 environment and the way in which events (e.g., mouse clicks, key presses) are handled. In addition, a BHO allows the voice extension module 125 to respond to external events, such as when a word is spoken, by embedding a speech recognition engine into the BHO. In this implementation, any speech recognition engine (e.g., a SAPI-compliant speech recognition engine) may be used to generate speech recognition events. The Internet Explorer Toolbar Component provides the same functionality as the BHO. In addition, the Internet Explorer Toolbar Component may make the voice extension module 125 perceptible as a toolbar of the browser 155.

The voice extension module 125 may process data and metadata of the user interface presented with the browser 120 to identify what functions are supported by the user interface. The voice extension module 125 is configured to register voice commands that may be used to control one or more graphical elements of the user interface such that the voice commands may be recognized. The commands that are registered are representative of multiple languages. For example, the voice extension module 125 may register a command for controlling a particular user interface element that is representative of one of the multiple languages. As a result, the voice extension module 125 may recognize one or more voice commands that are representative of one of the multiple languages for which commands were registered. Each of the registered voice commands corresponds to one or more user interface elements and to one or more operations for controlling the one or more user interface elements. When a voice command is recognized, one or more user interface elements corresponding to the voice command are identified. If the voice command corresponds to multiple user interface elements, the voice extension module 125 may prompt the user to select one of the multiple user interface elements. After a single user interface element is identified, the single user interface element is controlled as indicated by the recognized voice command.

The client computer system 105 and the application server 110 may be implemented using, for example, general-purpose computers capable of responding to and executing instructions in a defined manner, personal computers, special-purpose computers, workstations, servers, devices, components, or other equipment or some combination thereof capable of responding to and executing instructions. The components may receive instructions from, for example, a software application, a program, a piece of code, a device, a computer, a computer system, or a combination thereof, which independently or collectively direct operations, as described herein. The instructions may be embodied permanently or temporarily in any type of machine, component, equipment, storage medium, or propagated signal that is capable of being delivered to the components.

Further, the client computer system 105 and the application server 110 include a communications interface used to send communications through the network 115. The communications may include, for example, hypertext transfer protocol (HTTP) or HTTP over Secure Socket Layer (HTTPS) GET or POST messages, e-mail messages, instant messages, audio data, video data, general binary data, or text data (e.g., encoded in American Standard Code for Information Interchange (ASCII) format).

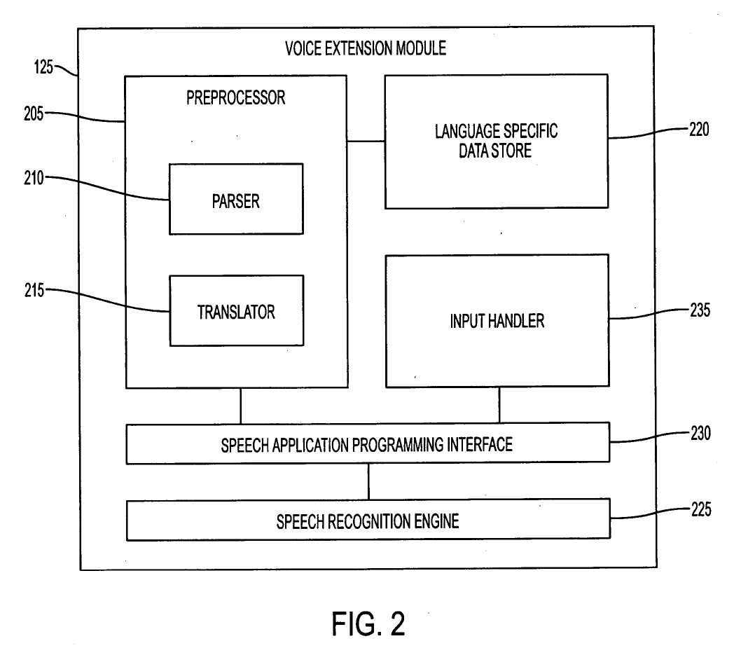

Referring to FIG. 2, the voice extension module 125 of FIG. 1 includes a preprocessor 205, which includes a parser 210 and a translator 215, and which uses a language specific data store 220. The voice extension module 125 also includes a speech recognition engine 225 that communicates with other components of the voice extension module 125 through a speech application programming interface 230, and an input handler 235.

The preprocessor 205 preprocesses user interface information specifying a user interface to an application to enable voice control of the user interface before the user interface is presented to a user. The preprocessor 205 may use a language of the user interface to voice-enable the user interface. In some implementations, the preprocessor 205 uses both the language of the user interface and English to voice-enable the user interface. More particularly, the preprocessor 205 preprocesses the user interface information by using the parser 210 to identify graphical elements of the user interface. The preprocessor 205 also uses the translator 215 to identify voice commands for controlling the user interface elements.

The parser 210 identifies operations provided by the user interface that may be used to control graphical elements of the user interface. The parser 210 may do so by identifying user interface elements within the information specifying the user interface using any conventional parsing techniques. For example, the parser 210 may parse an HTML web page describing the user interface to identify the graphical elements included in the user interface, such as text fields, password fields, checkboxes, radio buttons, and control buttons (e.g., submit and reset). The user interface elements may be identified by traversing the document object model (DOM) of the HTML web page. Alternatively or additionally, the user interface elements may be identified using a finite state machine. Identifying a user interface element may include identifying a name of the user interface element, options provided by a user interface element, or a value entered in the user interface element.

The translator 215 receives an indication of the identified user interface elements from the parser 210. The translator 215 identifies voice commands that may be used to control the identified user interface elements. In some implementations, a single voice command may correspond to multiple user interface elements, for example, when multiple user interface elements of a single type are included in the user interface. For example, the voice commands may include voice commands for selecting or activating each of the user interface elements. The voice commands also may include voice commands for modifying the user interface elements once selected. For example, the voice commands identified for a text field may include voice commands that enable free dictation of text to be entered into the text field. The voice commands identified for a selection list may include options included in the selection list such that vocalizing an option results in the selection of the option from the selection list. The translator may identify the voice commands based on types of the user interface elements, names and other information included in the user interface elements, and uses of the user interface elements.

The identified voice commands are representative of multiple languages. For example, the translator 215 may identify a voice command for a user interface element in a first language, and then may translate the identified voice commands into other languages. For example, when identifying voice commands for a button included in a user interface that is voice-enabled using English and Chinese, the translator 215 may identify the English word “button” as an appropriate voice command for the button in English. The translator 215 may translate the English word “button” into a corresponding Chinese word to identify an appropriate voice command for the button in Chinese. Alternatively, the translator 215 may identify or may receive an indication of one of the multiple languages that will be used to control the user interface, and the translator may identify voice commands that are representative of the one of the multiple languages.

The translator 215 also registers the voice commands with the speech recognition engine 225 and the input handler 235. Registering the voice commands with the speech recognition engine 225 and the input handler 235 enables the voice commands to be handled properly when recognized. The translator 215 may identify and register the voice commands as one or more command and control grammars from which specific commands may be recognized, or as one or more context free or natural language grammars from which multiple voice commands may be recognized. A grammar is a specification of words or expected patterns of words to be listened for by the speech recognition engine 225. Using command and control grammars significantly increases the accuracy and efficiency of voice input. This is because it is much easier to recognize which of a small number of words identified in a grammar was spoken than to determine which of a very large number of possible words was spoken.

Specifying the voice commands in command and control grammars requires that the user remembers the exact voice commands from the command and control grammars that correspond to particular user interface elements in order to control the particular user interface elements. However, command and control grammars may be easier for the translator 215 to identify than natural language grammars. On the other hand, natural language grammars provide for an easier interaction by enabling multiple synonymous voice commands to correspond to a single user interface element. Therefore, the user is not required to remember a specific voice command for controlling a particular user interface element. Instead, the user may control the particular user interface element by issuing one of the synonymous voice commands included in the grammar. In a well defined natural language grammar, the synonymous voice commands represent voice commands that the user would naturally identify for the particular user interface element. As a result, the user may control the particular user interface element without having to remember a potentially unnatural voice command that corresponds to the particular user interface element.

If the translator 215 identifies the voice commands as grammars, the grammars may be command and control grammars, context free grammars, spelling interface grammars, dictation interface grammars, VoiceXML built-in grammars, or other types of grammars. A command and control grammar is a list of voice commands. A context free grammar for a voice command captures variations of how the voice command might be stated by a user such that the user is not required to state the voice command in a particular manner to control a corresponding user interface element. Spelling interface grammars enable words to be spelled, and dictation interface grammars facilitate freeform text dictation. VoiceXML grammars are grammars for specify types of data, such as dates, times, numbers, and digits.

Each of these types of grammars may be internationalized such that voice commands that are representative of multiple languages may be identified from these grammars. The command and control grammar is easiest to internationalize because the included voice commands simply may be translated into multiple languages. The context free grammar is more difficult to translate because the context free grammar depends on sentence structure used in a language of the context free grammar, which may be different than sentence structure of a language into which the context free grammar may be translated. As a result, language-specific context free grammars may need to be specified. Spelling interface grammars also may require language-specific grammars. However, characters from many languages do not map to the Roman alphabet, which prevents standard spelling interface grammars from being used for those languages. Spelling equivalents, such as Pinyin, for Asian languages, may be substituted in those cases. Dictation interface grammars may be internationalized by having a corresponding dictionary for every supported language and using the dictionary to translate a dictation interface grammar for one language into a dictation interface grammar for another language. The VoiceXML grammars may be difficult to internationalize because the VoiceXML grammars are provided by multiple parties and are not standardized.

The translator 215 may cause the user interface to be modified before being presented to the user, in order to make the user interface more “voice-friendly.” For example, translator 215 may add identifiers to elements of the user interface. Some elements may include XML data or other metadata that indicates an appropriate identifier for the element. This metadata may determine an appropriate identifier that may be added to the element to make it more voice-friendly. Additionally, some identifiers of user interface elements may be abbreviated. One way to shorten long identifiers is to register only a portion of the long identifier. For example, if the identifier is “Submit Changes for Processing,” it can be shortened to “Submit Changes” or “Submit.”The language specific data store 220 includes information used by the translator 215 when identifying voice commands for the identified user interface elements that are representative of multiple languages. For example, the language specific data store 220 may include grammars, dictionaries, alphabets, phonetic transliteration schema, and other information corresponding to each of the multiple languages. The translator 215 may identify voice commands for controlling the user interface that are representative of a first language, and grammars and dictionaries included in the language specific data store 220 may be used to translate the identified voice commands into corresponding voice commands that are representative of other languages. As another example, the translator 215 may identify multiple grammars that are representative of multiple languages from the language specific data store 220 such that voice commands for controlling the user interface may be recognized from the grammars. For example, the translator 215 may identify that the user interface may be controlled by providing commands that specify dates, and the language specific data store 220 may include multiple grammars that are representative of multiple languages from which commands for specifying dates may be recognized. The translator 215 may identify the multiple grammars to identify the multiple voice commands that are representative of multiple languages. In addition, the language specific data store 220 may include one or more utilities that aid in recognizing and responding to voice commands that are representative of the multiple languages. For example, the language specific data store 220 may include a utility for converting a voice command that represents a number in a particular language into an actual numeral, and vice versa.

The speech recognition engine 225 recognizes voice commands that have been previously registered by the translator 215. More particularly, when a user of the user interface speaks, the speech recognition engine 225 parses the speech to identify one of the registered voice commands. The speech recognition engine 220 may use a grammar identified by the translator 215 to enhance its ability to recognize specific combinations of spoken words and phrases as previously registered voice commands. When a voice command is recognized, the speech recognition engine 225 generates an indication of the recognized voice command. The indication of the recognized voice command is passed to the input hander 215. In one implementation, the speech recognition engine 220 is ViaVoice provided by International Business Machines of Armonk, N.Y. In another implementation, the speech recognition engine 220 is the Speech Recognition Engine provided by Microsoft Corporation of Redmond, Wash.

In some implementations, the speech recognition engine 225 may be configured to recognize voice commands that are representative of multiple languages. In such implementations, the voice extension module 125 may include multiple speech recognition engines 225 to allow recognition of voice commands that are representative of the multiple languages. Each of the speech recognition engines may be configured to recognize voice commands that are representative of a particular language from voice input received from a user. For example, one implementation of the voice extension module 125 may include a first speech recognition engine that is configured to recognize voice commands that are representative of English and a second speech recognition engine that is configured to recognize voice commands that are representative of a non-English language, such as Chinese, Japanese, or Korean. In general, dissimilar languages may be recognized effectively in parallel using one or more speech recognition engines because voice commands typically do not correspond to more than one of the dissimilar languages. In such implementations, the translator 215 registers the identified voice commands with the appropriate speech recognition engines, based on the languages represented by the voice commands.

The speech application programming interface (SAPI) 230 enables voice commands to be registered with the speech recognition engine 225. In addition, the SAPI 230 enables the speech recognition engine to provide indications of a recognized voice command to the input handler 235. More particularly, the SAPI 230 provides one or more functions that may be used by the translator 215 to register a voice command with the speech recognition engine 15 225. In addition, the SAPI 230 provides one or more functions that may be used by the speech recognition engine 225 to identify a recognized voice command for the input handler 235. The SAPI 230 enables different implementations of the speech recognitions engine 225 to be used in the voice extension module 125 without detection by the preprocessor 205 or the input handler 235. In implementations where the speech recognition engine is the Speech Recognition Engine provided by Microsoft, the SAPI 230 may be SAPI 5.0, also provided by Microsoft. In implementations where the speech recognition engine 225 is ViaVoice, which is provided by IBM, the SAPI 230 may be the Speech Manager Application Programming Interface (SMAPI), also provided by IBM.

The input handler 235 maintains a mapping of voice commands to user interface elements to be controlled in response to the voice commands. The translator 215 registers the voice commands and the corresponding user interface elements with the input handler such that a user interface element corresponding to a recognized voice command may be controlled. When an indication of a recognized voice command is received, the input handler 235 identifies the voice command that has been recognized. The input handler 235 uses the mapping to identify one or more user interface elements corresponding to the recognized voice command, which may be a user interface element that was selected or activated with a previously recognized voice command. If the recognized voice command corresponds to multiple user interface elements, the input handler 235 may prompt for selection of one of the multiple user interface elements. The input handler 235 then signals for the identified user interface element to be controlled as indicated by the recognized voice command. Prior to doing so, the input handler 235 may save information describing a current state of the user interface, such that, for example, modifications to the identified user interface element may be undone. The input handler 235 also may signal for the execution of any additional tasks, as defined by the behavior of the user interface or visual focusing used in the overall user interface strategy. The input handler 235 helps to ensure that consistent action is taken regardless of whether the identified user interface element is controlled with a mouse or a keyboard, or in response to an equivalent voice command.

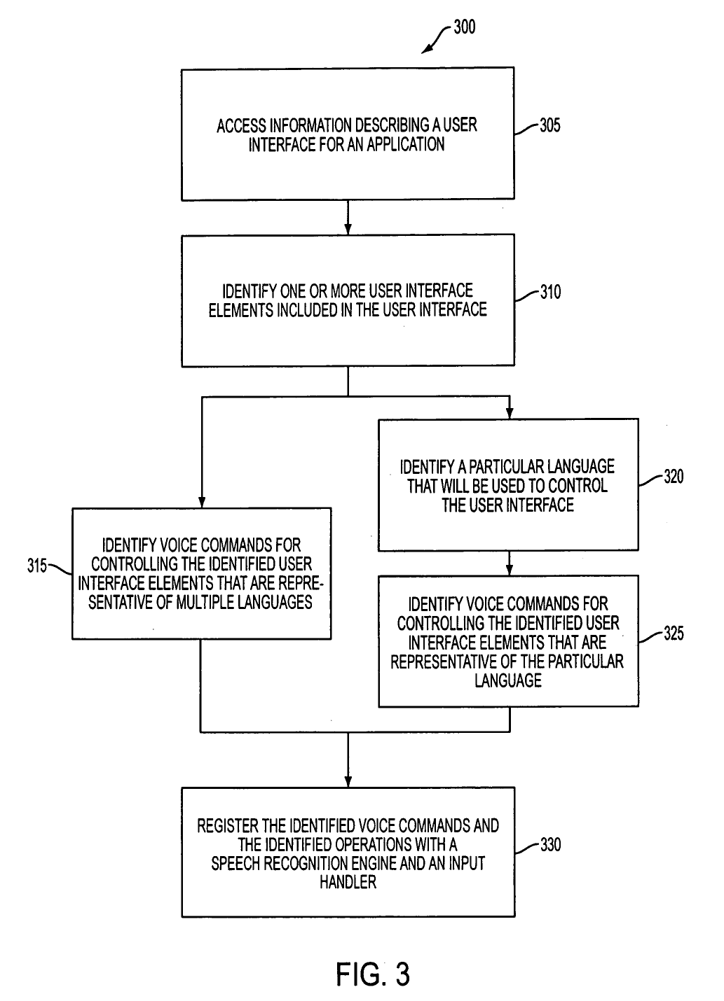

Referring to FIG. 3, a process 300 is used to voice-enable a user interface. More particularly, the process 300 is used to register voice commands for controlling graphical elements of a user interface that are representative of multiple languages. The user interface may be the user interface presented in the browser 120 of FIG. 1. The process 300 is executed by a voice extension module, such as the voice extension module 125 of FIGS. 1 and 2. More particularly, the process 300 is executed by a preprocessor of the voice extension module, such as the preprocessor 205 of FIG. 2.

The preprocessor first accesses information describing a user interface for an application (305). More particularly, a parser of the preprocessor, such as the parser 210 of FIG. 2, accesses the information. For example, the parser may access information specifying a user interface that is received from an application server on which the application is executing, such as the application server 110 of FIG. 1. The information describing the user interface may identify one or more user interface elements that are included in the user interface. For example, the information may be an HTML document identifying various user interface elements that may be controlled by a user. The information also may include JavaScript code or any other control mechanism conventionally used by web browsers. Alternatively or additionally, the information may include metadata that describes the user interface and functions provided by the user interface.

The preprocessor identifies one or more user interface elements included in the user interface (310). More particularly, the parser identifies the user interface elements. For example, the parser may parse the HTML document using any conventional parsing techniques, such as a finite state machine. In one implementation, the parser identifies only those elements of the user interface that may be controlled. In other words, the parser may identify user interface elements with which a user may interact, such as a text field or a selection list, and may not identify other user interface elements, such as an image or a label.

The preprocessor identifies voice commands for controlling the identified user interface elements. More particularly, a translator of the preprocessor, such as the translator 215 of FIG. 2, identifies the voice commands. The parser passes the translator indications of the identified user interface elements, and the translator identifies voice commands for controlling the identified user interface elements. The voice commands may be identified based on types of the user interface elements, names and other information included in the user interface elements, and uses of the user interface elements.

For example, the following user interface element may be included in the user interface and may be identified by the parser for the translator: “<INPUT TYPE=‘button’NAME=‘but_xyz’VALUE=‘save changes’ >”. This user interface element displays a button allowing a user to initiate saving changes. The translator may identify “save changes” as a voice command with which with the button may be selected. In addition, the translator may identify “button” as a more generic voice command with which the button, and other buttons included in the user interface, may be selected. As a result, the user interface element may be controlled in response to multiple voice commands, which may be advantageous in cases of decreased recognition performance.

The voice commands may be representative of multiple languages. The translator may identify such voice commands using information stored in a language specific data store, such as the language specific data store 220 of FIG. 2. If multiple languages will be used to control the user interface with the voice commands, then the translator identifies voice commands for controlling the identified user interface elements that are representative of the multiple languages (315). For example, the translator may identify voice commands for controlling the identified user interface elements that are representative of one of the multiple languages. The translator then may translate the identified voice commands into voice commands that are representative of others of the multiple languages.

Alternatively, when only one language will be used to control the user interface, the translator identifies a particular language that will be used to control the user interface (320). The translator may do so by prompting a user of the user interface to identify the particular language. Alternatively or additionally, the translator may identify the particular language using information and settings from a computer system on which the user interface is presented, such as the client computer system 105 of FIG. 1. For example, the computer system may include an indication of a locale in which the computer system is used. The particular language may be identified as a language typically used in the locale of the computer system. As another example, the translator may identify the particular language as a language represented by text included in the user interface. More particularly, if an indication of the title of the user interface includes French words, then the translator may determine that the particular language is French. The translator then identifies voice commands for controlling the identified user interface elements that are representative of the particular language (325).

The preprocessor registers the identified voice commands and the corresponding user interface elements with a speech recognition engine and an input handler (330). More particularly, the translator registers the identified voice commands with a speech recognition engine, such as the speech recognition engine 225 of FIG. 2. In implementations where the voice extension module includes multiple language-specific speech recognition engines, the translator registers each of the identified voice commands an appropriate speech recognition engine, based on a language represented by the voice command. The translator may register the identified voice commands with the speech recognition engine through a SAPI, such as the SAPI 230 of FIG. 2. Registering the voice commands with the speech recognition engine enables the voice commands to be recognized such that the corresponding user interface element may be controlled.

In addition, the translator registers the voice commands and the corresponding user interface elements with an input handler, such as the input handler 235 of FIG. 2. Registering the voice commands and the corresponding user interface elements with the input handler may include enabling the input handler to identify and to signal for control of a user interface element for which a corresponding voice command was recognized. Once the identified voice commands have been registered, the user interface may be displayed.

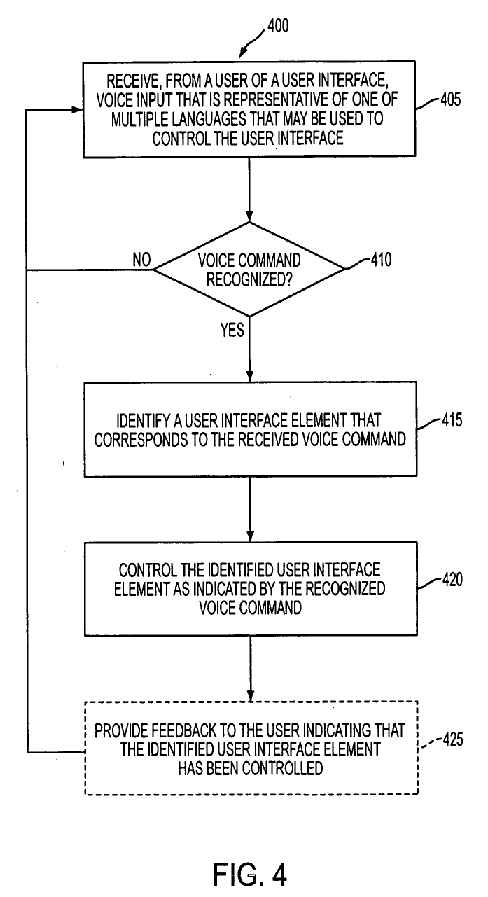

Referring to FIG. 4, a process 400 is used to control a voice-enabled user interface in response to voice input from a user. The user interface may be a user interface presented in the browser 120 of FIG. 1. The user interface may have been voice-enabled as a result of the execution of the process 300 of FIG. 3. The process 400 is executed by a voice extension module, such as the voice extension module 125 of FIGS. 1 and 2. More particularly, the process 400 is executed by a speech recognition engine and an input handler of the voice extension module, such as the speech recognition engine 225 and the input handler 235 of FIG. 2.

The process begins when the voice extension module receives voice input from a user of the user interface (405). The user may generate the voice input by speaking into a microphone of a client computer system on which the user interface is displayed, such as the microphone 150 of the client computer system 105 of FIG. 1. The client computer system provides the voice input received from the microphone to the voice extension module, which provides the voice input to the speech recognition engine. In implementations where the voice extension module includes multiple language-specific speech recognition engines, the voice recognition module may provide the voice input to each of the speech recognition engines.

The voice input received from the user may be representative of one of the multiple languages supported by the voice extension module. To generate voice input that is representative of a particular language, the user may freely speak words from the particular language. The user also may spell the words in an alphabet associated with the particular language. The words also may be spelled in an alphabet that typically is not associated with the particular language. In other words, the words may be phonetically transliterated into the alphabet that is not associated with the particular language, and then the transliterated words may be spelled in that alphabet. For example, if the voice input is representative of Chinese, the voice input may be transliterated into the Roman alphabet that is typically associated with English using, for example, the Pinyin transliteration schema, because characters of the Roman alphabet may be more easily recognized than Chinese characters when spoken. The user may spell the transliterated voice input using the Roman alphabet to provide the voice input to the speech recognition engine.

Each of the speech recognition engines determine whether the voice input is recognized as a voice command for controlling a user interface element (4 1 0). In other words, the speech recognition engine parses the voice input to determine whether a portion of the voice input represents a voice command that was registered with the speech recognition engine during the process 300 that was used to voice-enable the user interface.

If a voice command is recognized from the voice input, then the speech recognition engine that recognized the voice command passes an indication of the recognized voice command to the input handler. The speech recognition engine may pass the indication of the recognized voice command to the input handler through a SAPI through which the speech recognition engine and the input handler communicate, such as the SAPI 230 of FIG. 2. The input handler identifies a user interface elements that correspond to the received voice command (415). The user interface elements may be identified from a mapping of voice commands to user interface elements that is maintained by the input handler.

The mapping may relate the voice command to multiple user interface elements, in which case the input handler may prompt the user to select one of the multiple user interface elements. For example, input handler may identify the multiple user interface elements on the user interface with a numbered label. The input handler may prompt the user to identify a number of a label corresponding to a desired user interface element, and the user interface element corresponding to the identified number may be selected as corresponding to the received voice command. In other words, selecting one of the user interface elements by a corresponding label clarifies the voice command initially received from the user. The numbers of the labels may have been registered with the speech recognition engine previously such that a label may be identified in response to the user speaking the number of the label. The labels may be semi-transparent overlays placed over the corresponding user interface elements. Using semi-transparent overlays enables the identification of one of the user interface elements without substantially affecting the appearance of the user interface elements.

The input handler signals for the identified user interface element to be controlled as indicated by the recognized voice command (420). For example, if the recognized voice command includes data to be entered in the identified user interface element, then the input handler signals for the data to be entered in the identified user interface element. As another example, if the recognized voice command identifies an option to be selected from a selection list, then the input handler may signal for the selection of the identified option from the selection list. Prior to signaling for the identified user interface element to be controlled, a current state of the user interface may be recorded such that, for example, modifications to the identified user interface element may be undone.

The input handler also may provide feedback indicating that the identified user interface element has been controlled to the user (425). In one implementation, the input handler may signal for the identified user interface element to be highlighted with a visual identifier. For example, if the identified user interface element is an icon, button, radio button, or check box, the user interface element may appear as if selected with a mouse. For selection lists, the options in the list may be displayed so that the user can make a selection. Text fields may be highlighted with a colored border and the active cursor is placed in them, to signal that the user has entered data entry mode for that field. In typical implementations, the visual feedback provided to the user is associated positionally with the identified user interface element.

In another implementation, the input handler may signal for an audio message indicating that the identified user interface element has been controlled to be presented to the user with a speaker of the client computer system, such as the speaker 145 of FIG. 1. The audio message may identify and describe the control of the identified user interface element. The audio message may be a pre-recorded sound or audio generated by a TTS system. The audio message may be representative of a language in which the voice input was originally received. The content included in the audio message may be properly formatted to ensure maximum understandability in the language of the voice input. Prerecorded sounds may be used for a more “professional” sounding audio message, and TTS systems may be used to generate audio that is based on dynamic content created as a result of the user interface element being controlled.

After the identified user interface element has been controlled (430), or if a voice command was not recognized from the input received from the user (410), the voice extension module listens for additional voice input from the user such that additional user interface elements may be controlled. In this manner, the voice extension module enables voice commands to be processed at any time another voice command is not being processed, such that the user may issue repeated voice commands to interact with the user interface.

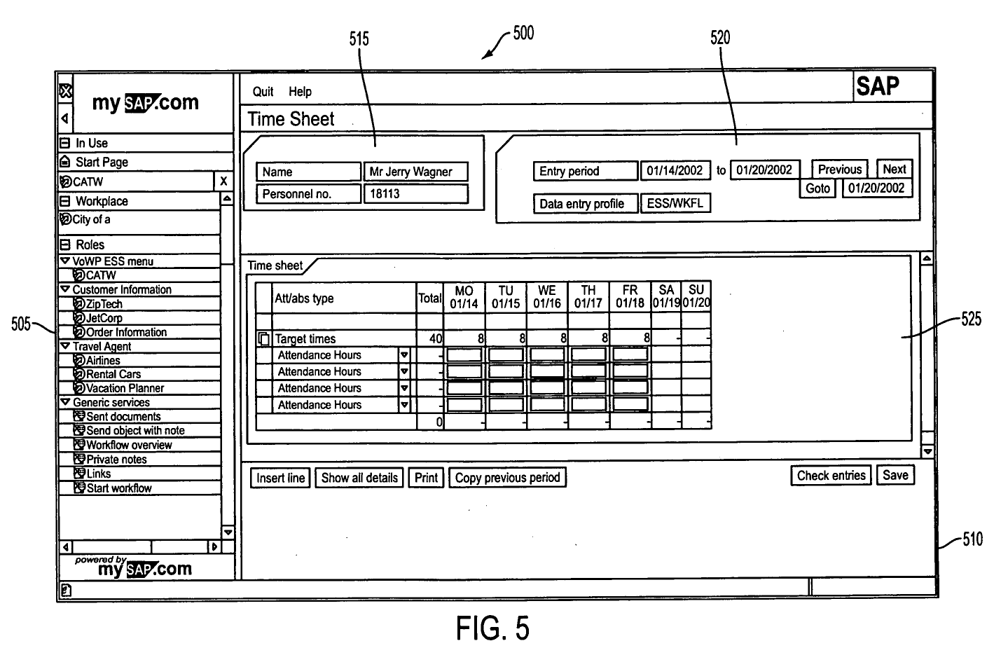

FIGS. 5-7 describe a voice-enabled electronic timekeeping application in which voice commands may be issued to control a graphical element of a user interface of the electronic timekeeping application. Referring to FIG. 5, a web portal allows a user to select various applications. The application window 500 includes two screen areas: a menu area 505 listing the various applications and a display area 510. The menu 505 is subdivided into several areas including a “Roles” area allowing a user to select tasks based on several indicated roles. The application begins with the focus area set to the “Roles” menu. The focus area may be indicated by a visual cue such as, for example, a colored line surrounding the focus area. The user may select to begin the electronic timekeeping application (named “CATW”) by speaking “CATW.” This command initiates the application using display area 510.

The electronic timekeeping application includes three general components that are displayed in display area 510. These components include the following: a user identification component 515, a time period component 520, and a time entry component 525. The user identification component 515 lists the user's name and personnel number. The time period component 520 lists the displayed time period and allows the user to switch to other time periods. The time entry component 525 allows a user to modify and/or enter time for the time period indicated by the time period component 520. The visual cue is moved to the display area 510 indicating that this area now has priority for command interpretation.

The time entry component 525 includes what looks like a spreadsheet with columns indicating the days in the time period and rows indicating various categories of time entry, such as, for example, annual leave, attendance hours, business trip, compensation flex time, compensation overtime, education/training, family medical leave, holiday, jury duty, long term disability, meeting, personal time, severance pay, or short term disability. Various text fields corresponding to each row/column combination are available for data entry.

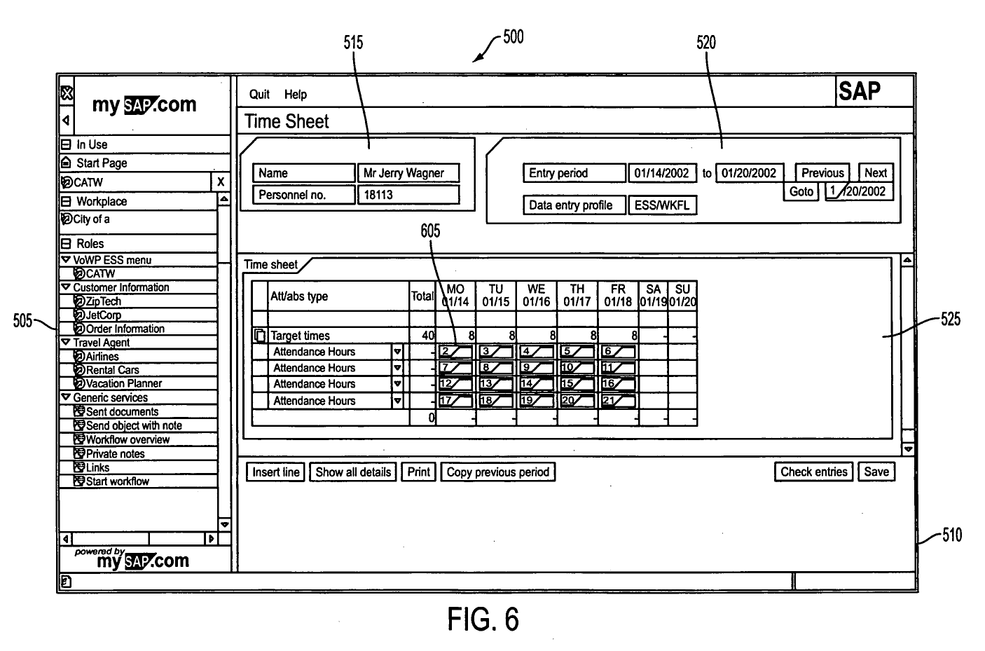

Referring to FIG. 6, a user may desire to enter the number eight in the upper leftmost text field of the time entry component 525. A user is enabled use one or more of multiple languages supported by the application window 500 to issue voice commands to enter the number eight into the upper leftmost text field. In some implementations, the language that may be used may be the language represented by text presented in the application window 500. For example, if the text of the application window 500 is presented in Chinese, the user may be enabled to issue Chinese voice commands to enter the number eight into the upper leftmost text field. In other implementations, the user may be enabled to provide voice commands in languages that are not visually reflected on the application window 500.

To enter the number eight into the text field, the user may say “text field” in one of the supported languages. The language used to say “text field” may be different than a language previously used to say “CATW.” The time entry component 525 includes multiple text fields, and the command “text field” does not uniquely identify one of them. As a result, each possible text field within the time entry component 525 is indicated by a representational enumerated label, such as the representational enumerated label 605 that identifies the upper leftmost text field of the time entry component 525. Label “1” is placed in the text field in the time period component 520. The remaining labels “2-21” are placed in the text fields of the time entry component 525. The user may identify the target text field by speaking its corresponding number, again, in the same or a different language.

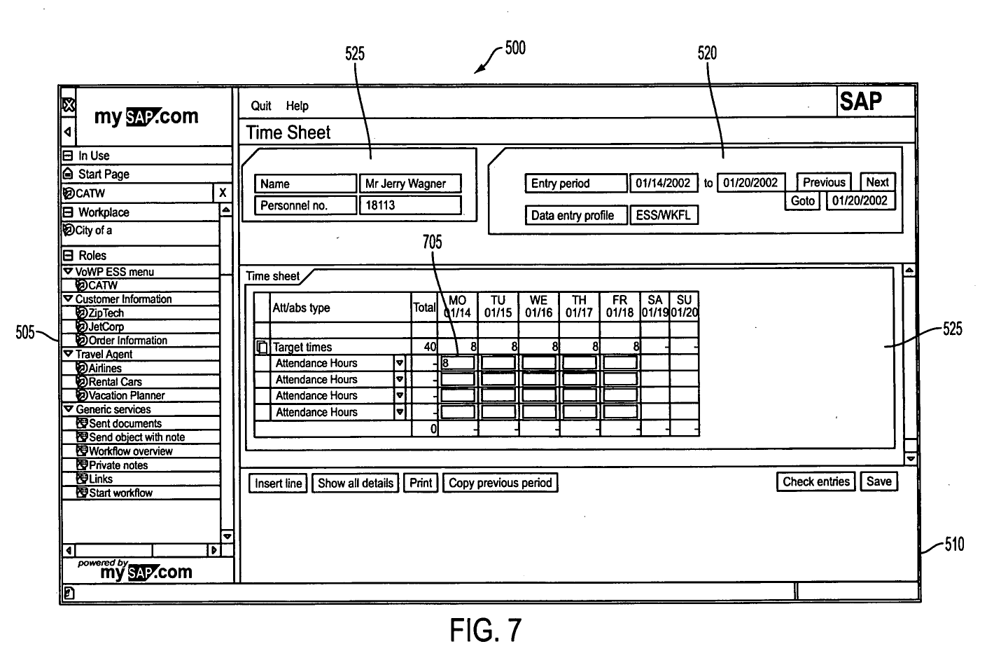

Referring to FIG. 7, the user selects the upper leftmost text field 705 in the time entry component 525 by saying “two.” After the user input is received, the representational enumerated labels disappear and the system prepares for data entry in the text field 705 by entering a data entry mode. A blue outline serves as a visual cue to indicate to the user that the system is in data entry mode and will enter any data entry dictation in the text field with the blue outline. An audio message indicating that data may be entered in the text field 705 also may be presented.

In data entry mode, an assigned grammar may be used to improve speech recognition performance. The electronic timekeeping application expects users to enter the number of hours worked in each text field of the time entry component 525, so a grammar may be assigned to those text fields that recognizes numbers. The user may then dictate the contents of the text field by saying the desired number. In this example, the user speaks “eight” and the system enters the number eight into the text field 705 and exits data entry mode.

FIGS. 5-7 illustrate a user interface for an electronic timekeeping system with which single voice commands may be issued to control a graphical element of the user interface. The described techniques may be used to provide voice control in any graphical user interface.

The techniques for voice-enabling user interfaces are described above in the context of enabling control of graphical elements of the user interfaces with voice commands. More particularly, the described techniques may be used to select, activate, and modify user interface elements in response to voice commands. However, such techniques also may be applied to signal for execution of high level operations that include multiple operations involving individual user interface elements in response to a single voice command. More particularly, voice commands for such high level operations that are representative of multiple languages may be registered and recognized to signal for execution of the high level operations. For example, voice commands in multiple languages may be used to signal for execution of semantic operations as described in U.S. patent application Ser. No. _______ [Docket 13909-169001], referenced above.

Specific voice commands are described throughout as being used to signal for graphical elements of a user interface to be controlled. In other words, only the specific voice commands may be used to signal for the user interface elements to be controlled. Other implementations of the described techniques may enable natural language phrases to signal for the user interface elements to be controlled. For example, instead of controlling the user interface elements in response to a specific voice command being recognized, the user interface elements may be controlled in response to a natural language phrase being recognized from one or more grammars that specify multiple natural language phrases for controlling the user interface elements.

The techniques for voice-enabling user interfaces are described above in the context of a web-based user interface presented in a web browser. More particularly, the techniques are described in the context of a client-server architecture in which a user interface is separated from an application corresponding to the user interface. Such an architecture enables or requires the user interface to be voice-enabled without modifying the application, because the user interface is not a component of the application. The described techniques may be used to voice-enable other user interfaces that are separated from corresponding applications. For example, the described techniques may be used to voice-enable a graphical user interface that is a standalone application and that is separated from a corresponding application. In addition, the described techniques also may be applied in other architectures in which an application and a corresponding user interface are not separated. In such architectures, voice-enabling the user interface may require modification of the application.

The described systems, methods, and techniques may be implemented in digital electronic circuitry, computer hardware, firmware, software, or in combinations of these elements. Apparatus embodying these techniques may include appropriate input and output devices, a computer processor, and a computer program product tangibly embodied in a machine-readable storage device for execution by a programmable processor. A process embodying these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

It will be understood that various modifications may be made without departing from the spirit and scope of the claims. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. An internationalized voice user interface comprising:
a user interface; and
a voice extension module associated with the user interface and configured to voice-enable the user interface, the voice extension module including:
a speech recognition engine;
a preprocessor configured to register with the speech recognition engine one or more voice commands for controlling the user interface, the one or more voice commands being representative of multiple languages; and
an input handler that receives an initial voice command that is representative of one of the multiple languages and communicates with the preprocessor to control the user interface as indicated by the initial voice command, the initial voice command being one of the one or more voice commands registered with the speech recognition engine by the preprocessor.

2. The internationalized voice user interface of claim 1 wherein the voice extension module further includes a language specific data store that includes information that identifies at least one voice command for controlling the user interface, the at least one voice command being representative of at least one of the multiple languages.

3. The internationalized voice user interface of claim 1 wherein the preprocessor identifies one of the multiple languages that will be used to provide voice commands for controlling the user interface and registers with the speech recognition engine one or more voice commands for controlling the user interface, the one or more voice commands being representative of the identified language.

4. The internationalized voice user interface of claim 3 wherein the preprocessor registers with the speech recognition engine only one or more voice commands that are representative of the identified language.

5. The internationalized voice user interface of claim 1 wherein the voice extension module further includes a speech application programming interface (API) that enables the preprocessor to register the voice commands with the speech recognition engine and that enables the speech recognition engine to communicate the initial voice command to the input handler.

6. The internationalized voice user interface of claim 1 wherein the preprocessor comprises:
a parser configured to parse the user interface to identify one or more user interface elements included in the user interface; and
a translator configured to register with the speech recognition engine one or more voice commands for controlling the one or more identified user interface elements, the one or more voice commands being representative of multiple languages.

7. The internationalized voice user interface of claim 1 wherein the user interface is at least one form a group including a hypertext markup language (HTML) document presented in a web browser, a standalone application, and a user interface for a web services application.

8. A voice extension module for internationalizing a voice-enabled user interface comprising:
a speech recognition engine;
a preprocessor configured to register with the speech recognition engine one or more voice commands for controlling a user interface, the one or more voice commands being representative of multiple languages; and
an input handler that receives an initial voice command that is representative of one of the multiple languages and communicates with the preprocessor to control the user interface as indicated by the initial voice command, the initial voice command being one of the one or more voice commands registered with the speech recognition engine by the preprocessor.

9. The voice extension module of claim 8 further comprising a language specific data store that includes information that identifies at least one voice command for controlling the user interface, the at least one voice command being representative of at least one of the multiple languages.

10. The voice extension module of claim 8 wherein the preprocessor identifies one of the multiple languages that will be used to provide voice commands for controlling the user interface and registers with the speech recognition engine one or more voice commands for controlling the user interface, the at least one voice command being representative of the identified language.

11. The voice extension module of claim 10 wherein the preprocessor is further configured to register with the speech recognition engine only voice commands that are representative of the identified language.

12. The voice extension module of claim 8 further comprising a speech application programming interface (API) that enables the preprocessor to register the voice commands with the speech recognition engine and that enables the speech recognition engine to communicate the initial voice command to the input handler.

13. The voice extension module of claim 8 wherein the preprocessor comprises:
a parser configured to parse the user interface to identify one or more user interface elements included in the user interface; and
a translator configured to register with the speech recognition engine one or more voice commands for controlling the one or more identified user interface elements, the one or more voice commands being representative of multiple languages.

14. A method for providing an internationalized voice user interface, the method comprising:
accessing information specifying a user interface;
registering with a speech recognition engine one or more voice commands for controlling the user interface to enable voice control of the user interface, the one or more voice commands being representative of multiple languages; and
controlling the user interface as indicated by an initial voice command that is representative of one of the multiple languages, the initial voice command being one of the one or more voice commands registered with the speech recognition engine.

15. The method of claim 14 wherein registering one or more voice commands comprises:
identifying one of the multiple languages that will be used to provide voice commands for controlling the user interface; and
registering with the speech recognition engine one or more voice commands that may be used to control the user interface, the one or more voice commands being representative of the identified one of the multiple languages.

16. The method of claim 15 wherein registering one or more voice commands that are representative of the identified one of the multiple languages comprises registering one or more voice commands that are representative of only the identified one of the multiple languages.

17. The method of claim 14 wherein registering one or more voice commands that may be used to control the user interface comprises:
parsing the information specifying the user interface to identify one or more user interface elements included in the user interface; and
registering one or more voice commands for controlling each of the one or more identified user interface elements.

18. The method of claim 14 wherein registering one or more voice commands that are representative of the multiple languages comprises:
registering one or more voice commands that are representative of one of the multiple languages based on the information specifying the user interface; and
registering one or more other voice commands that are representative of another of the multiple languages based on the one or more voice commands that are representative of the one of the multiple languages.

19. The method of claim 18 further comprising clarifying the initial voice command such that the initial voice command corresponds only to a manner in which the user interface is controlled in response to the initial voice command.

20. The method of claim 14 further comprising providing feedback that is representative of a language that is represented by the initial voice command.
